(19) United States
(12) Patent Application Publication
(10) Pub. No.: US 2003/0058385 A1
(43) Pub. Date: Mar. 27, 2003

(54) Liquid crystal display device

(76) Inventors: Douglas J. McKnight, Boulder, CO (US); Terry J. Scheffer, Hilo, HI (US)

Correspondence Address: James C. Scheller, Jr., BLAKELY, SOKOLOFF, TAYLOR & ZAFMAN LLP, Seventh Floor, 12400 Wilshire Boulevard, Los Angeles, CA, 90025-1026, US

(21) Appl. No.: 09/866,038

(22) Filed: May 24, 2001

(51) Int. Cl. G02F 1/1335

(52) U.S. Cl. 349/96

(57) ABSTRACT

The methods and apparatuses of the invention relate to liquid crystal displays. In one exemplary embodiment, a liquid crystal display includes a liquid crystal layer which has a twist angle in a range of about 60° to about 90° and includes a polarizer positioned to polarize light from a light source to create polarized light such that an angle β exists between a vector of the polarized light and a first alignment direction of the liquid crystal layer. The angle β is in a range of about −13° to about +13° and a value of Δnd is in a range of about 0.1 μm to about 0.2 μm where Δn is a birefringence of the liquid crystal layer and d is a thickness of the liquid crystal layer. Other features of the invention will be apparent from the accompanying drawings and description.

### BACKGROUND OF THE INVENTION

This invention relates generally to displays, such as liquid crystal displays. This invention relates, in one specific exemplary embodiment, to a reflective liquid crystal display operating in a transient display mode comprising a polarizer, an analyzer, a twisted nematic liquid crystal layer and a reflective layer.

There are a number of prior art non-transient reflective displays comprised of a polarizer, twisted nematic LC layer and a reflector. These display types are distinguished from each other through different combinations of the following three independently variable display parameters Δnd, φ and β where

(1) Δnd is the product of the birefringence of the liquid crystal Δn and the thickness of the liquid crystal layer d

(2) φ is the twist angle of the nematic layer where φ is determined from the relative angle between the alignment directions of the liquid crystal director at the two surfaces of the LC layer

(3) β is the angle between the E-field vector of the linearly polarized light exiting the polarizer and the alignment direction of the LC director at the input surface of the LC layer

A particular set of Δnd, φ and β values (Δnd, φ, β) can be considered to define a point in a three-dimensional space whose coordinate axes are Δnd, φ and β. The prior art reflective displays each occupy different regions of this space.

This differentiation between prior art reflective displays occurs because there is no single region in this space where all the display attributes such as brightness, contrast ratio, cell gap, tolerance to cell gap variation, operating voltage range, and viewing angle are simultaneously optimized. Generally it is only possible to optimize only a few display attributes at any one time and the region of (Δnd, φ, β) space occupied depends upon which of these attributes are emphasized over the others.

Table I lists the different regions of this parameter space that are occupied by prior art reflective displays.

TABLE I

| | U.S. Pat. | | Twist | Polarizer | Δnd (at λ = 550 | |
|---|---|---|---|---|---|---|
| Row | No. | Inventor | angle φ | angle β | nm) | |
| 1 | 4,019,807 | Boswell | 45° | 0° | ˜0.3 | μm |
| 2 | 4,378,955 | Bleha | 45° | 22.5° | ˜0.4 to 0.8 | μm |
| 3 | 5,870,164 | Lu | 46 to 62° | −6 to 6° | 0.39 to 0.69 | μm |
| 4 | 5,726,723 | Wang | 46 to 89° | 0° or 90° | 0.35 to 0.70 | μm |
| 5 | 5,361,151 | Sone- | 63° | 0° or 90° | 0.18 to 0.22 | μm |
| | | hara | | | | |
| 6 | 5,139,340 | Oku- | 0 to 70° | 35° to 115° | 0.2 to 0.7 | μm |
| | | mura | | | | |
| 7 | 5,490,003 | Van | 50 to 68° | β = φ/2 | 0.32 to 0.37 | μm |
| | | Sprang | | | | |
| 8 | 5,926,245 | Kwok | 47 to 57° | −15 to +5° | 0.47 to 0.57 | μm |
| 9 | 5,933,207 | Wu | 70 to 90° | ˜20° | 0.10 to 0.40 | μm |

The first row of Table I refers to the parameters described in U.S. Pat. No. 4,019,807. To increase the reflectivity of the powered state and to lower the operating voltage, a layer twist angle of 45° was chosen and the E-field vector of the linear polarized light was oriented parallel to the input director, i.e., β=0. This mode is referred to as the hybrid field effect mode. A value of Δnd is not specified in this patent, however a thickness d of 2 μm is given and the nematic liquid crystal is an ester material. Cyano type ester liquid crystals are known to have relatively high birefringence values of around 0.15, so the value of Δnd may be estimated to be approximately 0.3 μm.

The second row of Table I refers to the parameters described in U.S. Pat. No. 4,378,955. In this patent orienting the polarizer at an angle β=22.5° instead of β=0°, as specified in U.S. Pat. No. 4,019,807, optimizes color performance by making it possible to project black-white gray scale images with superimposed color symbology. The value of Δnd is not explicitly specified although a 2 to 4 μm cell gap filled with biphenyl type liquid crystal is specified. Since biphenyl liquid crystals are known to have relatively high birefringence values of around 0.2, the Δnd range may be estimated to extend from around 0.4 μm to 0.8 μm.

The third row of Table I refers to the φ, β, Δnd parameter space specified in U.S. Pat. No. 5,870,164. A twist angle of 54° is shown to optimize the reflectivity of the powered state compared with the 45° twist angle of the two patents listed in rows 1 and 2 of Table I. The conversion efficiency is approximately 100% when Δnd obeys the simple formula Δnd/λ=[1−(φ/π)²]^{1/2} which for φ=54° is Δnd/λ=0.954. Δnd/λ values ranging from 0.7 to 1.25 are specified. In green light with a wavelength of 550 nm this range of Δnd/λ values is equivalent to a Δnd range of 0.39 to 0.69 μm.

The fourth row of Table I refers to the φ, β, Δnd parameter space described in U.S. Pat. No. 5,726,723. This patent describes a reflective display that has a twist angle of 55° and Δnd is given by the formula 0.55 [1−(φ/π)²]^{1/2}. For this display, a region φ, β, Δnd in the parameter space has been found which makes it possible to use cells with larger cell gaps and which are less sensitive to cell gap variations, thus optimizing the manufacturing process.

The fifth row of Table I refers to the φ, β, Δnd parameter space described in U.S. Pat. No. 5,361,151. For this display a region in the parameter space has been found which optimizes the reflectivity in the unpowered state and which makes it possible to use larger cell gaps thereby increasing the production efficiency in making such displays. A display of this patent uses (φ=63°, β=0. Δnd/λ values ranging from 0.33 to 0.40 are specified. In green light with a wavelength of 550 nm this range of Δnd/λ values is equivalent to a Δnd range of 0.18 to 0.22 μm.

The sixth row of Table I refers to the φ, β, Δnd parameter space described in U.S. Pat. No. 5,139,340. For this display a region in the parameter space has been found which optimizes the reflectivity in the powered state and also minimizes the spectral sensitivity of reflectance vs. wavelength so that a monochrome display can be viewed without objectionable coloration.

The seventh row of Table I refers to the φ, β, Δnd parameter space described in U.S. Pat. No. 5,490,003. For this display a region in the parameter space has been found which optimizes the reflectivity and contrast ratio and prevents gray scale inversions. For this display the polarizer angle P is half the twist angle φ, so φ ranging from 50° to 68° would indicate a β ranging from 25° to 34°. Δnd/λ values ranging from 0.58 to 0.68 are specified. In green light with a wavelength of 550 nm this range of Δnd/λ values is equivalent to a Δnd range of 0.32 to 0.37 μm. This display configuration is referred to as the self-compensating reflective display.

The eighth row of Table I refers to the φ, β, Δnd parameter space described in U.S. Pat. No. 5,926,245. For this display a region in the parameter space has been found which optimizes reflectivity and contrast ratio and reduces color dispersion in a cell that is thick enough to be easily manufacturable.

The ninth row of Table I refers to the φ, β, Δnd parameter space described in U.S. Pat. No. 5,933,207. For this display a region in the parameter space has been found which optimizes for low operating voltage, wide viewing angle and high reflectivity and contrast ratio. The inventors refer to this display as a mixed mode twisted nematic display, or MTN display.

The displays described in these prior art references are generally designed to operate in what may be characterized as a static mode. In a static mode, the liquid crystal reaches a saturated state (in which the response of the liquid crystal, to a change in the electric field surrounding the liquid crystal, is substantially complete). This static mode exists for a substantial portion of the frame period for a single “video” frame (e.g. an entire screen of data in a sequence of screens designed to show “motion,” as in a motion picture). Often, such displays have a frame period of about 30 milliseconds (ms) or about 16 ms, which corresponds to a typical frame period in display systems, such as television's NTSC video standard. The foregoing displays, however, do not generally produce adequate results when the liquid crystal material in the display is switched so fast over time that the liquid material is almost always in a substantially dynamic state (e.g. the liquid crystal does not generally reach a saturated state due to the rapid switching between display states). One example of a display in which the liquid crystal is generally in a non-saturated state is a display which is illuminated with a sequence over time of colors, such as red, green, and blue, rather than a generally white light which includes substantially all colors. Such a display is often referred to as a field-sequential color display (e.g. see examples described in U.S. Pat. No. 6,046,716). The sequence of separate colors (e.g. red then green then blue) are displayed as 3 separate color subframes within one conventional full-color frame. Thus, a color subframe lasts only about ⅓ of a full frame (e.g. ⅓ of 30 ms or ⅓ of 16 ms).

In all the related art display configurations listed in rows 1-9 of Table I the inventors have chosen the three parameters φ, β and Δnd to optimize certain combinations of display attributes under generally static, steady state drive conditions. Under static drive conditions a constant voltage is applied for a sufficient period of time that the liquid crystal has completely responded to it. This is generally the case in today's active matrix TFT (thin film transistor) displays where a constant voltage is placed on a pixel electrode for a full frame period of ˜16.7 ms before it may be changed to a different value. Except when displaying very fast moving images, most pixels do not change their states at every frame. Color in these types of displays is obtained either through the use of color mosaic filters for direct view applications, such as in a notebook computer, or through the superposition of three display panels in separate red, green or blue color channels, for projection applications.

### SUMMARY OF THE INVENTION

The methods and apparatuses of the invention relate to liquid crystal displays. In one exemplary embodiment, a liquid crystal display includes a liquid crystal layer which has a twist angle in a range of about 60° to about 90° and includes a polarizer positioned to polarize light from a light source to create polarized light such that an angle β exists between a vector of the polarized light and a first alignment direction of the liquid crystal layer. The angle β is in a range of about −13° to about +13° and a value of Δnd is in a range of about 0.1 μm to about 0.2 μm where Δn is a birefringence of the liquid crystal layer and d is a thickness of the liquid crystal layer. Other features of the invention will be apparent from the accompanying drawings and description.

### BRIEF DESCRIPTION OF THE DRAWINGS

The present invention is illustrated by way of example and not limitation in the figures of the accompanying drawings in which like references indicate similar elements.

FIG. 1 shows a simplified view of a reflective display of the present invention using a polarizing beamsplitter (PBS) as the polarizing element with the input polarization vector making an angle β with the input director of a twisted nematic liquid crystal layer.

FIG. 2 is a representation of a mathematical description of the display of the present invention showing the two orthogonal forward-propagating elliptically polarized eigenmodes that rotate exactly in step with the LC director as it twists through the layer.

FIG. 3 shows the region of polarizer input angles β of the display of the present invention, which are optimized for a reflective display under transient drive operation.

FIG. 4a shows a configuration of a reflective display of the present invention with φ=70°, Δnd=0.13 μm and β=−4.72.

FIG. 4b shows the elliptical state of polarization of the light at the reflector and at the output of the reflective display of the present invention for the example in FIG. 4a.

FIG. 5 shows the arrangement of color subframes in a field sequential color display of the present invention and a pixel waveform that generates a saturated green pixel.

FIG. 6a shows the simulated optical response to the waveform of FIG. 5 of a reflective display of the present invention (heavy curve) that has been optimized for transient drive compared with a display which has been optimized for static drive (light curve).

FIG. 6b is an expanded view of the response curves of FIG. 6a.

FIG. 7 shows another example of a display device of the present invention.

### DETAILED DESCRIPTION

The subject invention will be described with reference to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail.

The present invention, in one embodiment, is directed toward a display whose pixels operate in a transient state where the pixel voltage may change from one frame to the next, or even multiple times in one frame, regardless of whether the displayed image is changed or not. Such would be the case, for example, in a stereoscopic display system where the display is alternately presenting right and left eye views of a scene. To avoid flicker effects the right and left eye subframe periods must be much shorter than the conventional ˜16.7 ms frame period for TFT displays. Another example of transient operation would be for a display whose colors are generated by the field sequential color method. In this type of color display the frame period is divided into red, green and blue color subframes where the red, green and blue components of a color image are sequentially viewed at a high enough rate that the eye perceives them as a fused full color image. Although a green pixel, for example, may appear to be unchanging, it is actually being fully switched off during the red and blue subframe periods and is only turned on during the green subframe period. To avoid flicker and color break-up effects, the individual color subframe periods must be much shorter than the conventional ˜16.7 ms frame period for TFT displays. Under these circumstances, and especially at lower temperatures, the liquid crystal no longer has sufficient time to completely respond to a particular color subframe drive voltage before the voltage is changed to a new level for the next color subframe. Under these transient drive conditions we have determined that the particular set of variables φ, β and Δnd that optimize the brightness and color saturation of the display are quite different from the corresponding sets of variables described for the statically driven prior art displays listed in Table I.

The present invention in one embodiment is characterized by a Δnd value which lies in the range 0.1 to 0.2 μm, below the values required for optimal static efficiency in the prior art schemes including the 0.25 μm value of the optimal scheme described in U.S. Pat. No. 5,933,207. Furthermore, in the present invention the layer twist angles are in the range 60° to 90° and β is in the range of −13° to +13°. Under conditions of transient drive the embodiments of the present invention show a greatly enhanced brightness and color saturation compared with parameter choices of the prior art schemes which have been optimized for static drive.

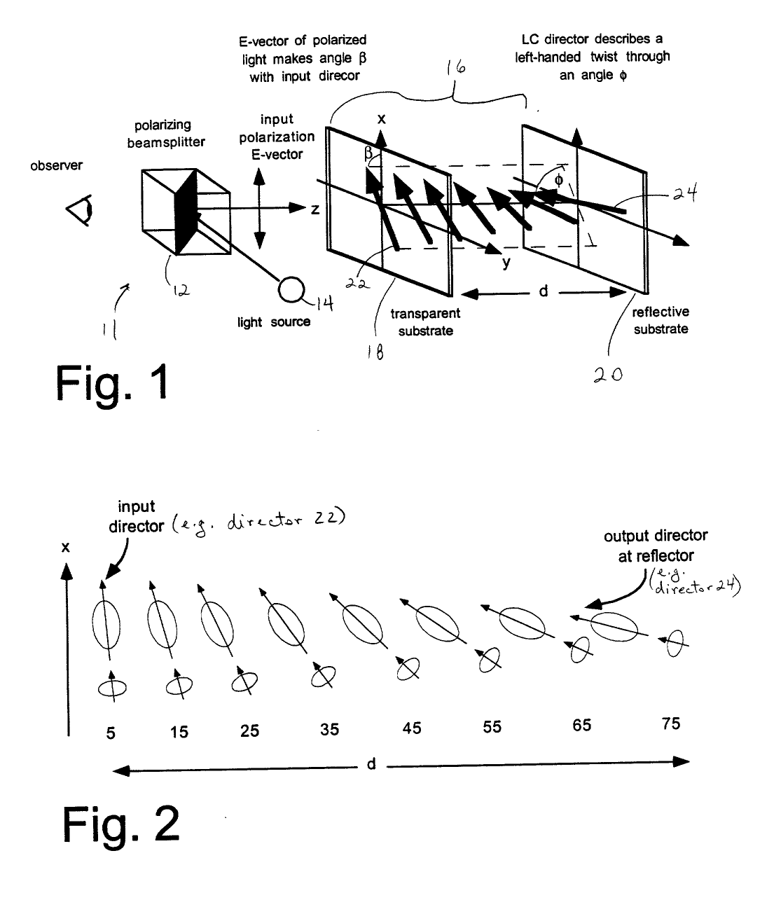

FIG. 1 is a simplified illustration of the geometry of a direct view embodiment 11 of the present invention using a polarizing beamsplitter 12 (PBS) as the polarizing element. Light from a light source 14 becomes linearly polarized upon reflection from the PBS and propagates in the z-direction toward the LC cell 16 with its E-vector being parallel to the x-direction as shown. The LC cell display cell 16 is comprised of a front, transparent substrate 18 and a rear, reflective substrate 20, both of which lie parallel to the x-y plane and are separated from each other by a cell gap distance d. In known liquid crystal displays d typically ranges from less than 1 μm to over 7 μm. The inner surfaces of the two substrate plates have various thin film coatings that include a transparent conductive coating such as ITO on the front substrate and a reflective coating such as aluminum on the rear substrate. Also present are alignment coatings on the two surfaces consisting of, for example, thin layers of polyimide material which have been rubbed in proscribed directions to impart a given orientation to the director of the adjacent LC material. Of course other alignment materials and orientation methods can also be used, such as special photosensitive polymers which have been processed by exposure to polarized UV radiation to impart an orientation to the director of the adjacent liquid crystal to each treated surface.

For the sake of simplicity the individual pixels are not shown in FIG. 1, but it is to be understood that an actual display cell, in one embodiment, would be provided with a plurality of individually addressable electrodes defining the pixels of the display. A further example of an LC display will be described below in conjunction with FIG. 7.

The alignment coating on the inner surface of the front substrate is processed to impart an orientation to the director of the adjacent LC such that its projection on the x-y plane makes an angle β with the x-axis. Thus, LC director 22 makes an angle of β relative to the x-axis. β is defined as the polarization input angle. The alignment coating on the inner surface of the rear substrate is processed to impart an orientation to the director of the adjacent LC such that its projection on the x-y plane makes an angle β+φ with the x-axis. Thus, the LC director 24 makes an angle of β+φ relative to the x-axis. Under these conditions the LC director inside the cell will uniformly twist through an angle φ in going from one side of the cell to the other. This angle φ is defined as the magnitude of the LC layer twist angle. In FIG. 1 a left-handed twisted structure is shown. The polarization input angle β is defined to be positive if the direction of the E-field vector of linear polarized light is included within the range of director orientation angles inside the cell, and negative if it is outside this range. For the embodiment shown in FIG. 1 the value of β is negative. It should be noted that for normal incidence viewing the same display performance is obtained if integer multiples of 90° are added to, or subtracted from, β.

The liquid crystal material can, for example, be a nematic liquid crystal with or without a chiral component to impart a pretwist to the liquid crystal. For the case where the twist angle φ is greater than 90° it is necessary to add a chiral component to the liquid crystal in order to sustain the twist angle. For the case where the twist angle φ is less than 90° no chiral component is necessary for this purpose, but it may nevertheless be advantageous to add a chiral component to speed up the response time or to eliminate any vestiges of reverse twist. The liquid crystal is characterized by a birefringence Δn, which is defined as the difference between its extraordinary refractive index and its ordinary refractive index. The birefringence values for typical liquid crystal mixtures vary between 0.08 and 0.25.

Under some circumstances it might be advantageous to insert a negative C plate, or its equivalent, between the polarizer or PBS and the transparent substrate to increase the viewing angle of the display.

Before discussing a detailed mode of operation of the present invention it is worthwhile to review what is known about all single polarizer, reflective TN displays. All these displays can be considered as having an input state of linear polarized light making an angle β with the input director and an output state of polarization which is determined by conditions of the TN layer. A useful mathematical description of what goes on inside the TN layer is as follows. A form of the solution to Maxwell's equations is two forward propagating eigenmodes in any uniform medium, including the uniformly twisted optical medium of a TN layer. In a TN layer these eigenmodes are elliptically polarized, orthogonal states whose major axes are parallel and perpendicular to the local LC director and rotate precisely in step with the twisted structure, experiencing the full rotation of the structure that they pass through. The ellipticity of both normal modes, defined as the ratio of the minor axis of the ellipse to the major axis of the ellipse, b/a is given by:

b/a=(φ/π)/(Δnd/λ+[(φ/π)²+(Δnd/λ)²]^{1/2})

From this formula it is important to understand that the ellipticity of the eigenmodes is only determined by the twist angle φ, the wavelength of light λ and the Δnd product. The input polarization angle β has no influence on the ellipticity of the eigenmodes.

FIG. 2 illustrates the eigenmodes in one embodiment of the present invention where φ=70°, Δnd=0.13 μm and λ=550 nm, corresponding to the green portion of the visible spectrum where the eye is most sensitive. According to the above formula, under these conditions b/a=0.562, indicating a considerable amount of ellipticity.

Using the eigenmode form of the solution to Maxwell's equations we see that there is a different refractive index associated with each of these eigenmodes, which introduces a phase shift between them as they propagate through the LC layer. This phase shift δ(z) is given by the formula

δ(z)=2π(z/d) [(φ/π)²+(Δnd/λ)²]^{1/2}

where z represents a location within the LC layer a distance z form the input substrate, with z=d at the rear substrate or reflector. The state of polarization of the light at any point within the layer is determined by superimposing the two eigenmodes, taking into account the relative phase shift between them. At the input to the LC cell there is no phase shift and the eigenmodes superimpose to give linear polarized light along the x-axis. Thus at the reflector where z=d the phase shift is δ(d)=2π [(φ/π)²+(Δnd/λ)²]^{1/2}.

A general expression for the static reflectivity R of the display shown in FIG. 1 is given by the following formula

$$R = 1 - {[ {cos}^{2} x + ( 1 - {a}^{2} ) / ( 1 + {a}^{2} ) {sin}^{2} x ]}^{2} - 4 {{a}^{2} [ {sin}^{2} x sin 2 β / ( 1 + {a}^{2} ) + sin x cos x cos 2 β / {( 1 + {a}^{2} )}^{1 / 2} ]}^{2}$$

where a=π/φ (Δnd/λ), x=φ (1+a²)^{1/2} and β is the polarizer input angle. For simplicity, this expression omits reference to losses such as imperfect reflectance of the reflector.

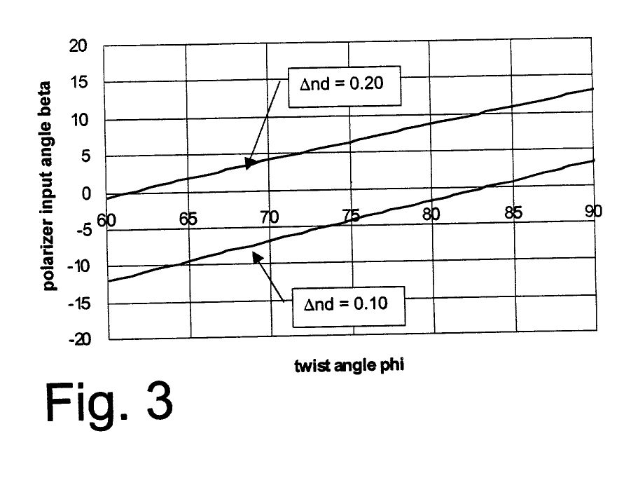

In a transient switching regime (e.g. when field sequential color illumination is used) we have found that values of Δnd in the range 0.1 μm≦Δnd≦0.2 μm result in particularly high reflectances. For a given value of Δnd and φ the reflectance can be optimized with respect to the polarizer input angle β. FIG. 3 plots the optimum polarizer input angle β as a function of the twist angle φ for values of Δnd of 0.1 μm and 0.2 μm. Note that within the range of twist angles extending from 60° to 90° and values of Δnd extending from 0.1 μm to 0.2 μm, an optimum polarizer input angle β varies between −13° and +13°.

Table II lists an optimum polarizer angle P of the present invention for the twist angle 60°, 70°, 80° and 90° for the case Δnd=0.13 μm and λ=550 nm. Also shown in the table is the ellipticity of the state of polarization at the reflector and at the output of the display after having been reflected through the LC layer.

TABLE II

| | Optimum polarizer | Ellipticity | |
|---|---|---|---|
| Twist angle φ | input angle β | at reflector | Ellipticity at output |
| 60° | −9.95° | 0.661 | 0.425 |
| 70° | −4.72° | 0.595 | 0.542 |
| 80° | +0.35° | 0.528 | 0.681 |
| 90° | +10.08° | 0.462 | 0.844 |

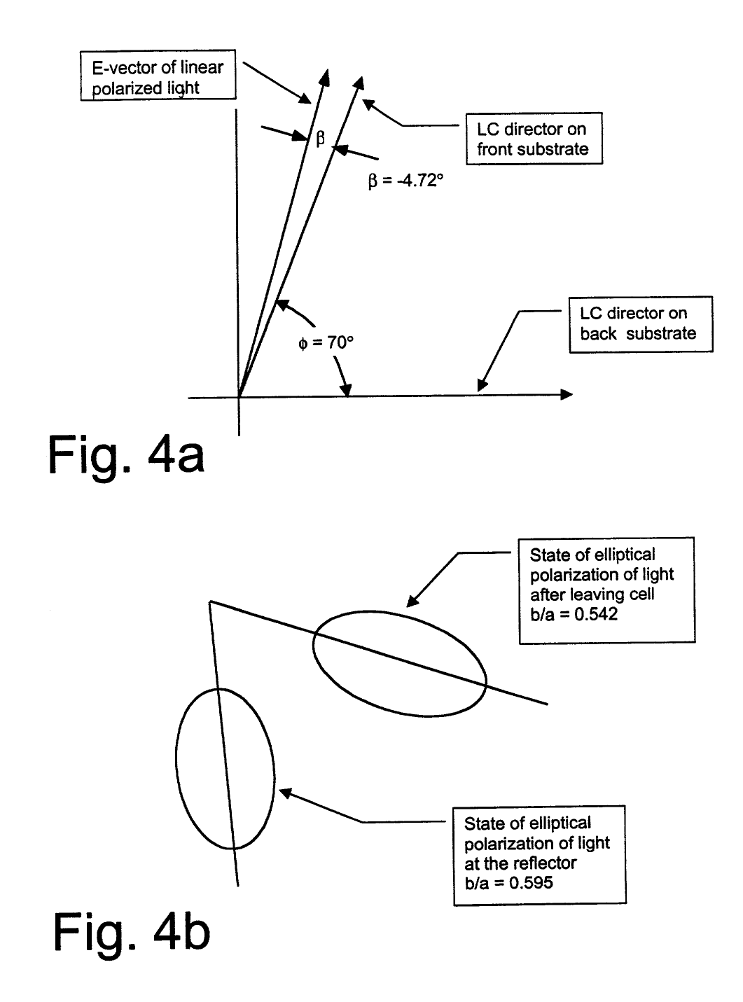

FIG. 4a shows the configuration of a reflective display of the present invention optimized for transient drive with a right-handed twist φ=70°, Δnd=0.13 μm and β=-4.72° as given in Table III. FIG. 4b shows the elliptical state of polarization of the light at the reflector and again at the output of the display corresponding to this example. Note that the state of polarization at these two locations is neither linear (ellipticity=0) nor circular (ellipticity=1), but quite elliptical.

Next, an example will be given of the present invention under conditions of transient drive where the colors are generated by the field sequential color method. For this type of display the frame period is divided into red, green and blue color subframes and the red, green and blue components of a color image are sequentially viewed under red, green and blue illumination. To realize this type of display the color of the display illumination rapidly cycles through red, green and blue light and the pixel values on pixel electrodes rapidly cycle through the R, G, and B component values (such as in the manner described in U.S. Pat. No. 6,046,716). Referring to the example shown in FIG. 1, the light source could consist of a white light source with a rotating wheel containing red, green and blue color filters placed in front of it. Alternatively, the light source could be an assembly of red, green and blue LEDs where each color LED (light emitting diode) is sequentially activated. Other techniques are also possible such as placing a color shutter either in front of the observer or in front of the white light source.

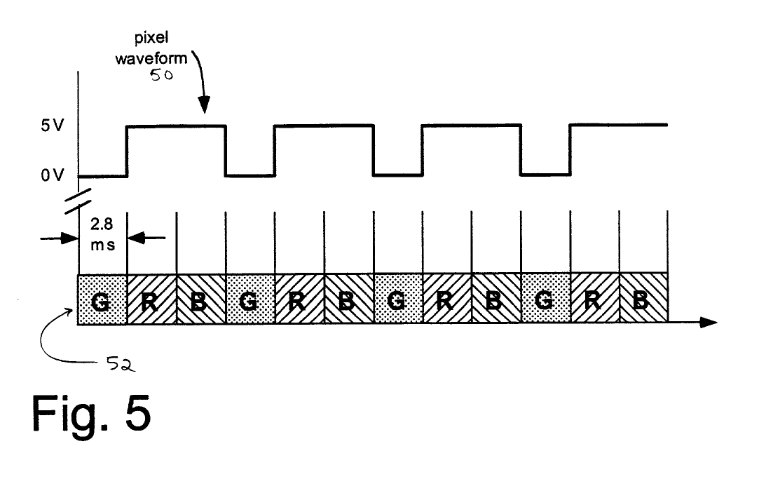

To avoid flicker and color break-up effects, the individual color subframe periods must be much shorter than a conventional ˜16.8 ms frame period for TFT displays. It has been found that if the conventional frame period is subdivided into 6 color subframes, each of 2.8 ms duration, then flicker and color break-up effects are almost completely suppressed. FIG. 5 shows an embodiment of this invention where the color subframe period is 2.8 ms. During the green subframe (G) the display shows the green components of the full color image and is illuminated with green light. During the red subframe (R) the display shows the red components of the full color image and is illuminated with red light. Δnd during the blue subframe (B) the display shows the blue components of the full color image and is illuminated with blue light. The sequential illumination pattern 52 shown in FIG. 5 is an example of sequential color subframes.

The pixel drive waveform 50 superimposed on FIG. 5 illustrates the voltage waveform applied across a pixel in the display of the present invention which is desired to have a saturated green appearance. When a PBS is used in conjunction with the present invention the result is a highly reflective state when no voltage is applied. This is sometimes referred to as a normally open or normally white (NW) display. With the pixel drive waveform shown, the pixel will be in a highly reflective state during the green subframe periods (G) when zero volts is applied and be in a state of very low reflectivity during the red (R) and blue (B) subframe periods when 5 volts is applied. Because the liquid crystal requires a certain time to respond to any voltage changes, and because the subframe period is so short, the liquid crystal will generally not have enough time to completely respond to its subframe voltage before the next subframe voltage is applied. Under such circumstances the display can be said to operate in a transient mode in which the state of the liquid crystal does not reach a saturated or settled state. In contrast to a conventional color LCD using color mosaic filters, it is easy to see that a field sequential color display is usually operating in the transient mode even when the displayed color image is completely stationary.

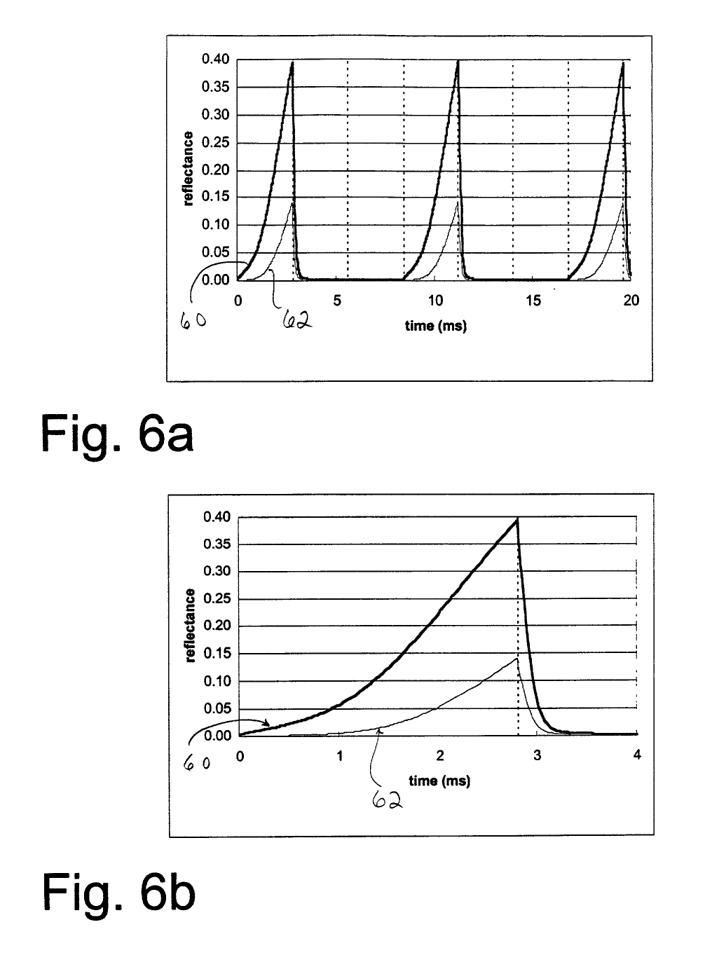

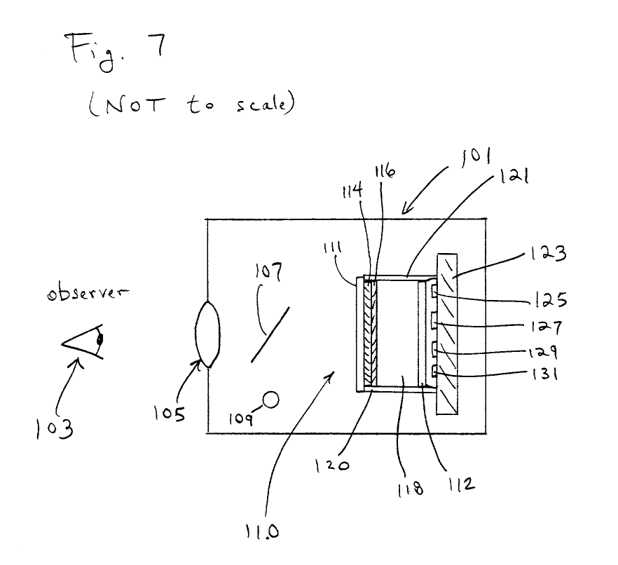

FIGS. 6a and 6b illustrate the response of a liquid crystal display of the present invention to the pixel drive waveform of FIG. 5 and compares it to the response of the MTN display described in U.S. Pat. No. 5,933,207 whose display parameters have been optimized for conventional, static drive conditions where β=20°. Table III shows a comparison of parameters for these two displays. These data were computed using DIMOS, a commercial LCD modeling software package available from autronic-Melchers GmbH in Karlsruhe, Germany.

TABLE III

| | Example of | MTN display of |
|---|---|---|
| | invention | U.S. Pat. No. |
| | optimized for | 5,933,207 |
| | transient | optimized for |
| | operation | static operation |
| Cell gap d | 1.3 μm | 1.3 μm |
| Ordinary refractive index | 1.500 | 1.500 |
| Extraordinary refractive index | 1.600 | 1.600 |
| Birefringence Δn | 0.100 | 0.100 |
| Δnd product | 0.13 μm | 0.13 μm |
| Input polarizer angle β | −5° | +20° |
| Twist angle φ | 70° | 90° |
| Pretilt angle α | 5° | 5° |
| Splay elastic constant K₁₁ | 10 pN | 10 pN |
| Twist elastic constant K₂₂ | 5 pN | 5 pN |
| Bend elastic constant K₃₃ | 16 pN | 16 pN |
| Perpendicular dielectric constant ε₁ | 4.5 | 4.5 |
| Parallel dielectric constant ε₂ | 15 | 15 |
| Rotational viscosity γ₁ | 0.2 Pa s | 0.2 Pa s |

FIG. 6a shows the optical response of an example of the present invention (heavy curve) 60 during a period of 7 color subframes (dotted vertical lines) illustrating the increase in reflectivity during the green subframe and suppression of the reflectivity during the red and blue color subframes. The light curve 62 in FIG. 6a shows the optical response of the display disclosed in U.S. Pat. No. 5,933,207 which has been optimized for static operation. A closer view of the response of these two displays can be seen in the expanded view shown in FIG. 6b covering a time period which includes the first green subframe and part of the next red subframe. Note that the reflectivity of the display of the present invention is consistently higher than that of the prior art display disclosed in U.S. Pat. No. 5,933,207 over the entire subframe. At the end of the 2.8 ms subframe, for example, the reflectivity of the display of the present invention is 2.8 times greater than that of the prior art display—if the green light source were flashed just at this instant, than the display would appear 2.8 times brighter. The reflectivity improvement is even greater if the green light is turned on for a larger fraction of the green subframe. For example if the green light were kept on during the entire subframe, then the perceived reflectivity would be determined by the area under the reflectivity curve. Comparing the area under the two curves in FIG. 6b it is determined that the integrated reflectivity of the present invention is 4.1 times greater than the prior art display which has been optimized for static drive conditions.

FIG. 7 shows an example of a display device of the present invention. In one embodiment of this example, the device 101 may be a headmounted display which projects an image through lens 105 (or a group of lenses) to the viewer's eye 103 which is in close proximity to the device 101. Numerous examples of headmounted displays (also sometimes referred to as “brought to the eye” displays) are known and various optical configurations for these displays are also known. It will be appreciated that the example shown in FIG. 7 shows a generalized and simplified optical configuration and that the various known optical configurations may instead be used. The display device 101 also includes a polarizer 107 (which may be a polarizing beam splitter) and a light source 109 (which may be a set of Red, Green and Blue LEDs which provide field sequential color illumination). In one method of operating device 101, light from the light source 109 is polarized and reflected toward the reflective liquid crystal cell 110 which then spatially modulates the light and reflects back the modulated light to create an image. The image is specified by voltages applied on the plurality of pixel electrodes (usually arranged in a rectangular array), such as reflective pixel electrodes 125, 127, 129, and 131. The image then appears visible to the observer 103 through the polarizer 107 and lens 105 (or group of lenses). In the example shown in FIG. 7, the cell 110 may be a liquid crystal on silicon (LCoS) device in which the pixel electrodes are disposed on an integrated circuit 123. Examples of such LCoS devices are well known; see, e.g., U.S. Pat. No. 6,046,716. The cell 110 includes a cover glass substrate 111 which has a transparent electrode 114 (e.g. an ITO electrode) deposited on a surface of substrate 111. An alignment layer 116 is attached to or formed on the transparent electrode 114. Another alignment layer 112 is attached to or formed on an upper portion of the substrate of the integrated circuit 123. Spacers 120 and 121 define a gap d between the alignment layers 112 and 116 and a liquid crystal material 118 is disposed in this gap. In one particular exemplary embodiment of the cell 110, the twist angle may be about 80° and the β angle may be about 5° or less and Δnd may be about 0.16 μm.

It will be appreciated that the invention may also be used in reflective liquid crystal displays which drive projection systems where the image is projected onto a screen and observers view the screen rather than looking into a display device's orifice.

While the invention has been particularly shown and described with respect to illustrative and preferred embodiments thereof, it will be understood by those skilled in the art that the foregoing and other changes in form and details may be made therein without departing from the spirit and scope of the invention which should be limited only by the scope of the appended claims.

What is claimed is:

1. A liquid crystal display device comprising:
a liquid crystal layer having a twist angle (φ) of about 60° to about 90°;
a polarizer positioned to receive light from a light source and to polarize said light, said polarizer polarizing said light such that an angle β exists between a vector of said polarized light and a first alignment direction of said liquid crystal layer;
wherein β is in a range of about −13° to about +13° and wherein a value of Δnd is about 0.1 μm to about 0.2 μm where Δn is a birefringence of the liquid crystal layer and d is a thickness of the liquid crystal layer.

2. A liquid crystal display device as in claim 1 further comprising:
a first substrate coupled to said liquid crystal layer;
a second substrate coupled to said liquid crystal layer, said first substrate and said second substrate defining said thickness d.

3. A liquid crystal display device as in claim 2 wherein said second substrate comprises a reflective surface.

4. A liquid crystal display device as in claim 3 wherein said reflective surface comprises a plurality of reflective pixel electrodes disposed on said second substrate.

5. A liquid crystal display device as in claim 4 wherein said second substrate comprises an integrated circuit.

6. A liquid crystal display device as in claim 2 wherein said first substrate is transparent and comprises a transparent electrode.

7. A liquid crystal display device as in claim 6 wherein a first alignment layer is created on said first substrate, said first alignment layer determining said first alignment direction and wherein a second alignment layer is created on said second substrate, said second alignment layer determining a second alignment direction and wherein said twist angle is determined by the angle between said first alignment direction and said second alignment direction.

8. A liquid crystal display device as in claim 7 wherein said polarizer is a polarizing beamsplitter.

9. A liquid crystal display device as in claim 2 wherein said light source is a field sequential light source which separately provides a plurality of different colored light over time which correspond to separate color fields.

10. A liquid crystal display device as in claim 9 wherein said light source comprises 3 differently colored LEDs (light emitting diodes) which are sequentially and separately turned on.

11. A liquid crystal display device as in claim 2 further comprising:
at least one lens positioned to receive modulated light from said liquid crystallayer.

12. A liquid crystal display device as in claim 11 wherein said liquid crystal display device is housed within a head mounted display.

13. A liquid crystal display device as in claim 9 wherein each separate color field of said separate color fields lasts for no longer than about 8 milliseconds.

14. A liquid crystal display device as in claim 2 wherein said twist angle is about 80° and said β is in a range of about −5° to about +5° and said Δnd is in a range of about 0.13 μm to about 0.17 μm.
